(19) United States
(12) Patent Application Publication
(10) Pub. No.: US 2017/0155943 A1
(43) Pub. Date: Jun. 1, 2017

(54) METHOD AND ELECTRONIC DEVICE FOR CUSTOMIZING AND PLAYING PERSONALIZED PROGRAMME

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Runrun LIU, Beijing (CN)

(21) Appl. No.: 15/243,347

(22) Filed: Aug. 22, 2016

Related U.S. Application Data
(63) Continuation of application No. PCT/CN2016/088942, filed on Jul. 6, 2016.

(30) Foreign Application Priority Data
Dec. 1, 2015 (CN) 201510867061.2

(51) Int. Cl. H04N 21/2668; H04N 21/643; H04N 21/442; H04N 21/262; H04N 21/258

(52) U.S. Cl. CPC H04N 21/2668; H04N 21/26258; H04N 21/25891; H04N 21/4424; H04N 21/64322

(57) ABSTRACT

The present disclosure provides a method and electronic device for customizing and playing personalized programme. The method includes: detecting an event that a user boots an Internet television terminal, and recording boot time; calling a programme list customized by the user, wherein the programme list is divided into several programme sub lists according to several continuous periods of time with different durations in a time sequence; matching the boot time with the several periods of time and obtaining a period of time matched with the boot time; and extracting a programme sub list corresponding to the period of time matched, and starting playing a programme for the user according to the programme sub list.

### CROSS-REFERENCE TO RELATED APPLICATIONS

This application is a continuation of international application No. PCT/CN2016/088942 filed on Jul. 6, 2016, and claims priority to Chinese Patent Application NO. 201510867061.2, entitled “Method and apparatus for customizing and playing personalized programme” and filed to China Patent Office on Dec. 1, 2015, the entire contents of which are incorporated herein by reference.

### TECHNICAL FIELD

The present disclosure relates to the field of Internet television, and in particular, to a method and electronic device for customizing and playing personalized programme.

### BACKGROUND

Internet television is a product of combining the Internet technology and the television technology. In the process of integrating two major media, i.e., television and network, Internet television not only retains the visual and vivid features of the television, but also has the on-demand interactive features of the Internet, thereby becoming a new medium integrating the advantages of the two media. The existing Internet television terminal is generally composed of a television box (Internet television set-top box) and a smart television capable of accessing the Internet. Through such a small computing terminal, i.e., the television box, many network functions such as web browsing, web video playing, applications installation and the like can be achieved in the traditional television, as long as the television box is connected to the traditional television by simply using an HDMI technology, component cable technology, or the like.

Based on the existing Internet television terminal, a user can customize a personalized programme list. However, the function customizing the existing personalized programme list is simplex, a series of programmes are just played in the specified order of the user in fact, and the specific viewing demand of the user, particularly the viewing time of the user are not taken in account. Therefore, the user cannot view the programme conforming to the viewing demand in a specific period of time. The user has to manually select a programme when wanting to view different programmes in different periods of time according to own preference, and the massive programme information causes the amount of the operation of the user to be greatly increased.

### SUMMARY

In view of above, an object of the disclosure is to provide a method and electronic device for customizing and playing personalized programme, so as to meet the viewing demand of the user in different periods of time, further enriching the function for customizing the personalized programme list.

According to a first aspect of embodiments of the disclosure, there is provided a method for customizing and playing personalized programme, which includes:

detecting an event that a user boots an Internet television terminal, and recording boot time;

calling a programme list exclusive to the user, wherein the programme list is divided into several programme sub lists according to several continuous periods of time with different durations in a time sequence;

matching the boot time with the several periods of time and obtaining a period of time matched with the boot time; and

extracting a programme sub list corresponding to the period of time matched, and starting playing a programme for the user according to the programme sub list.

According to a second aspect of embodiments of the present disclosure, there is provided a non-volatile computer storage medium which is stored with computer executable instructions, which are configured for performing any one of the above methods for customizing and playing personalized programme.

According to a third aspect of embodiments of the present disclosure, there is provided an electronic device including one or more processors and a memory, wherein, the memory is stored with instructions executable by the one or more processors, and the instruction are set to perform any one of the above methods for customizing and playing personalized programme.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for customizing and playing personalized programme according to an embodiment of the present disclosure;

FIG. 2 is a flow chart of a method for customizing and playing personalized programme according to another embodiment of the present disclosure;

FIG. 3 is a schematic structural diagram of an apparatus for customizing and playing personalized programme according to another embodiment of the present disclosure;

FIG. 4 is a schematic structural diagram of an apparatus for customizing and playing personalized programme according to another embodiment of the present disclosure;

FIG. 5 is a schematic structure diagram of hardware of an electronic device for customizing and playing personalized programme according to another embodiment of the present disclosure.

### DETAILED DESCRIPTION

Here the exemplary embodiments are described in details, examples of which are illustrated in the accompanying drawings. When the following description refers to the accompanying drawings, unless otherwise indicated, the same numerals in different figures denote the same or similar elements. The following exemplary embodiments described do not represent all embodiments consistent with the present disclosure. Instead, they are only examples of the apparatus and method consistent with some aspects of the present disclosure as detailed in the appended claims.

In order to make the objects, technical solutions and advantages of the present disclosure more clear and apparent, the present disclosure is further described below in details in conjunction with the embodiments with reference to the drawings.

It should be noted that, all description of “first” and “second” used in the embodiment of the disclosure are used to distinguish two different entities or parameters of the same name. Therefore, the “first” and “second” are merely convenient for expression, and should be not construed as limiting the embodiments of the disclosure, which are not illustrated any more in the following embodiments.

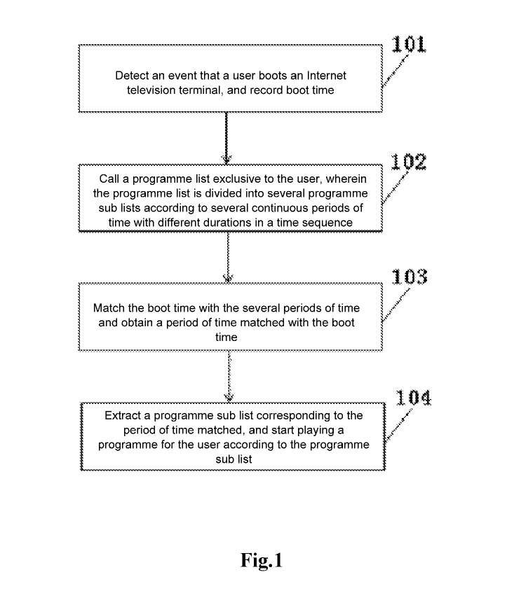

A method for customizing and playing personalized programme is provided according to an embodiment of the disclosure. FIG. 1 is a flow chart of a method for customizing and playing personalized programme according to the embodiment of the present disclosure.

The method for customizing and playing personalized programme includes the following steps 101 to 104.

In step 101, an event that a user boots an Internet television terminal is detected, and boot time is recorded.

The user views programme via the Internet television terminal, and the boot time is recorded when the user boots the Internet television terminal. The boot time recorded is preferably a tag time at a network terminal, or may also be local time which is calibrated with the network terminal. For the Internet television terminal, the user is generally a registered user, and each Internet television terminal has a unique device ID which may be bonded with the registered user. Therefore, user identity may be determined and user attribute information may be obtained by acquiring the device ID when the Internet television terminal is booted.

In step 102, a programme list customized by the user is called, and the programme list is divided into several programme sub lists according to several continuous periods of time with different durations in a time sequence.

According to the user identity determined and the user attribute information obtained in the previous step, the pre-stored exclusive programme list customized for the user is called. The programme list is divided into several programme sub lists according to several periods of time with different durations. These periods of time are continuous in a time sequence and a sum of these periods of time is just equal to a duration of one natural day. Further, each of these periods of time corresponds to one programme sub list. In the embodiment, the programme list includes four programme sub lists, that is, a first programme sub list corresponding to a period of time of 5:00-11:00, i.e., the morning in real time, a second programme sub list corresponding to a period of time of 11:00-14:00, i.e., the noon in real time, a third programme sub list corresponding to a period of time of 14:00-19:00, i.e., the afternoon in real time, and a fourth programme sub list corresponding to a period of time of 19:00-5:00 (the next day), i.e., the evening in real time.

In the embodiment, the programme list is generated directly for the user. As the generation of the programme list preferably refers to a playing record of the user, it is firstly detected whether the playing record of the user is stored. If the playing record of the user exists, the programme list is generated for the user according to the playing record of the user. For example, if the user has viewed “CCTV morning news” at 8:00 in the morning, the programme of “CCTV morning news” is added at 8:00 in the first programme sub list. Similarly, a programme is added into the corresponding programme sub list according to a part of playing record of the user in other period of time. For the period of time or a specific time slot in the period of time at which no playing record of the user exist, a programme is added according to preset default programme information. The default programme information includes multiple programmes corresponding to different periods of time (time slots), which are obtained according to audience rating statistics or user score ranking of different programmes, and generally can meet most user demands. If the playing record of the user does not exist, programmes included in respective default programme information are added directly into respective programme sub lists according to the default programme information, and the programme list is generated finally.

In step 103, the boot time is matched with the several periods of time and a period of time matched with the boot time is obtained.

In order to further meet viewing demands of the user in different periods of time and ensure that the user can view a programme of a respective period of time in the customized programme list in a specific period of time, in this step, the boot time obtained in the previous step is matched with the programme list. The matching refers to determining that the boot time belongs to a period of time corresponding to which programme sub list. For example, in the embodiment, it is detected that the user boots the Internet television terminal at 20:00, and the boot time is recorded to be 20:00. Through matching, it can be determined that the boot time obtained belongs to a period of time corresponding to the fourth programme sub list.

In step 104, a programme sub list corresponding to the period of time matched is extracted, and a programme is started to be played for the user according to the programme sub list.

According to a matching result in the previous step, the fourth programme sub list is extracted, and playing is started from a first programme included in the fourth programme sub list.

As can be seen from the above embodiments, in the method for customizing and playing personalized programme, the programme list is divided according to periods of time, and the boot time of the user is matched with the programme list. In this way, the user can view the preferred programme in a respective period of time whenever opening the Internet television terminal, no more operation is made by the user, and the viewing demands of the user are met well.

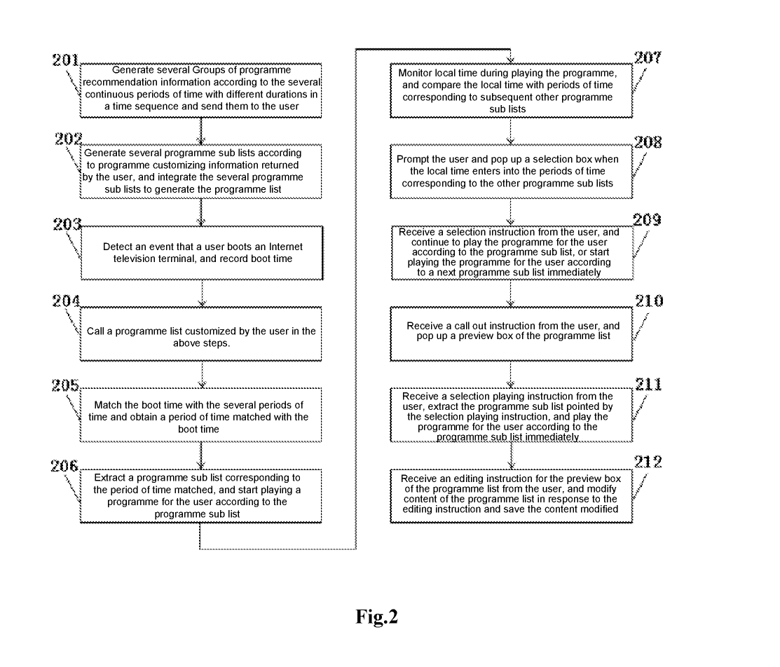

FIG. 2 is a flow chart of a method for customizing and playing personalized programme according to another embodiment of the present disclosure.

As a more specific embodiment, the method for customizing and playing personalized programme includes the following steps 201 to 206.

In the embodiment, a programme list is generated firstly, which is customized through editing by the user.

In step 201, several groups of programme recommendation information are generated according to several continuous periods of time with different durations in a time sequence, and the several groups of programme recommendation information are sent to the user.

In this step, the several groups of programme recommendation information are generated according to several periods of time. As the previous embodiment, the programme list in the present embodiment also includes four programme sub lists (the period of time and name corresponding to a specific programme sub list are the same as those in the previous embodiment). In other words, in present step, four groups of programme recommendation information are generated, and each group of the programme recommendation information corresponds to one programme sub list. Each group of programme recommendation information includes a plurality of programmes corresponding to the same period of time for user selection. Preferably, the programme recommendation information is generated according to a playing record of the user. Specifically, it is detected firstly whether the playing record of the user is stored. If the playing record of the user exists, the programme recommendation information is generated according to the playing record. For example, if the user has viewed “CCTV Morning News” at 8:00 in the morning, the “CCTV Morning News” and multiple similar programmes such as “Beijing morning News”, “Hunan morning News” and the like may be included in a first group of programme recommendation information (corresponding to a first programme sub list). Similarly, the same or similar programmes are added into programme recommendation information corresponding to the respective period of time (programme sub list), according to a part of playing record of the user in other periods of time. For a period of time or a specific time slot in a period of time at which the playing record of the user does not exist, a programme is added according to preset default programme information. The preset default programme information includes multiple programmes corresponding to different periods of time (time slots), which are obtained based on audience rating statistics or user score ranking for different programmes, and generally can meet most of user demands. If the playing record of the user does not exist, the programme recommendation information is generated according to the default programme information. Four groups of programme recommendation information after being generated are sent to the user.

In step 202, several programme sub lists are generated according to programme customizing information returned by the user, and the several programme sub lists are integrated to generate the programme list.

The user may customizes the programme list according to the programme recommendation information after receiving the programme recommendation information via the Internet television terminal. Specifically, after the programme recommendation information is received by the user, the programme recommendation information is shown for the user in a form of list, table, and the like, while a programme list template is provided for the user. There is not a programme in each period of time of each programme sub list in the programme list template. The user can select a programme from the programme recommendation information according to own preference, and edit it into the programme list template. For example, if the user is accustomed to view the news programme in the morning, the user may edit several news programmes into the first programme sub list; if the user is accustomed to view the teleplay in the evening, the user may edit the chasing teleplay into the fourth programme sub list. After the editing of the programme list template is completed by the user, the programme list template is returned as programme customizing information of the user. Then, four programme sub lists are generated according to the programme customizing information and then the four programme sub lists are integrated to generate a whole programme list.

In step 203, an event that a user boots an Internet television terminal is detected, and boot time is recorded.

In step 204, a programme list customized by the user in the above steps is called.

In step 205, the boot time is matched with the several periods of time and a period of time matched with the boot time is obtained.

In step S206, a programme sub list corresponding to the period of time matched is extracted, and a programme is started to be played for the user according to the programme sub list.

According to a playing way in the embodiment, when a programme is played according to one programme sub list, the playing of one programme may span periods of time corresponding to different programme sub lists. In this case, a playing state needs to be adjusted according to the viewing demands of the user, and the embodiment further includes steps 207 to 209.

In step 207, local time during playing the programme is monitored, and the local time is compared with periods of time corresponding to subsequent other programme sub lists.

In step 208, the user is prompted and a selection box is popped up when the local time enters into the periods of time corresponding to the other programme sub lists.

When the playing of the programme enters into a period of time corresponding to the subsequent programme sub list, the selection box is popped up for user selection. The selection box at least includes two buttons for user operation, which are set to keep on the current playing, and end the current playing and start playing from a first programme included in a next programme sub list, respectively.

In step 209, a selection instruction inputted by the user for the selection box is received, the programme continues to be played for the user according to the programme sub list, or the programme is started to be played for the user according to a next programme sub list, immediately.

Furthermore, the user can proactively preview a whole programme list and select a programme sub list to be played. The embodiment further includes steps 210 to 212.

In step 210, a call out instruction from the user is received, and a preview box of the programme list is popped up.

The preview box of the programme list is popped up for the user, in response to the call out instruction inputted by the user. The preview box of the programme list shows content of the whole programme list in a thumbnail view. The preview box of the programme list is an operable object, which can receive a selection playing instruction pointing to each programme sub list from the user.

In step 211, the selection playing instruction for the preview box of the programme list is received from the user, the programme sub list pointed by the selection playing instruction is extracted, and the programme is played for the user according to the programme sub list immediately.

Through the above steps, the user may end the current playing as required, or skip the playing of one or more programme sub lists, and directly play the programme sub list to be viewed.

In step 212, an editing instruction for the preview box of the programme list is received from the user, and content of the programme list is modified in response to the editing instruction and the content modified is saved.

The user can edit the programme list through the preview box of the programme list. When the user inputs the editing instruction for the preview box of the programme list, the programme list template and programme recommendation information described in the previous steps can be called. The programme customizing information is generated by editing the programme list template and the programme customizing information is returned. Accordingly, the programme list is updated and saved according to the programme customizing information returned by the user.

In some other embodiments, for the programme list generated according to the preset default programme information, a programme that is not of interest to the user may exist, due to the programme included in the programme list is not customized by the user itself. Therefore, the method may further include a step of updating the programme list: receiving evaluation information of the user after the playing of the programme list generated according to the preset default programme information is finished for the user, and updating content of the programme list according to the evaluation information. Specifically, after the playing of the programme is finished, an evaluation box is popped up for the user, which provides selector buttons such as “prefer or not prefer”, “for or against” and the like for user selection. After the user makes a selection, the evaluation information is generated and returned. A deletion operation, substitution operation and the like is performed to the respective programme in the programme list, that is, the programme list is updated, according to the evaluation information returned by the user.

In some other embodiments, in generating the programme list, when different programmes in the same time slot in the same period of time are selected, their priorities may be taken into account. For example, a live programme has a highest priority due to its timeliness, which is preferentially added in the programme list. The priorities of other programmes may be ranked according to the playing record of the user or a playing frequency for all users, and the other programmes are added sequentially in the programme list according to their priorities.

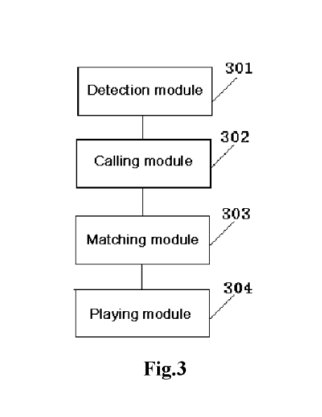

In another aspect, an apparatus for customizing and playing personalized programme is further provided according to an embodiment of the disclosure. FIG. 3 is a schematic structural diagram of an apparatus for customizing and playing personalized programme according to an embodiment of the present disclosure.

The apparatus for customizing and playing personalized programme includes:

a detection module 301, detecting an event that a user boots an Internet television terminal and recording boot time;

a calling module 302, calling a programme list exclusive to the user, wherein the programme list is divided into several programme sub lists according to several continuous periods of time with different durations in a time sequence;

a matching module 303, matching the boot time with the several periods of time and obtaining a period of time matched with the boot time; and

a playing module 304, extracting a programme sub list corresponding to the period of time matched, and starting playing a programme for the user according to the programme sub list.

As can be seen from the above embodiments, the apparatus for customizing and playing personalized programme according to the disclosure divides the programme list according to periods of time and matches the boot time of the user with the programme list, so that the user can view the preferred programme in a respective period of time whenever opening the Internet television terminal, no more operation is made by the user, and the viewing demands of the user are met well.

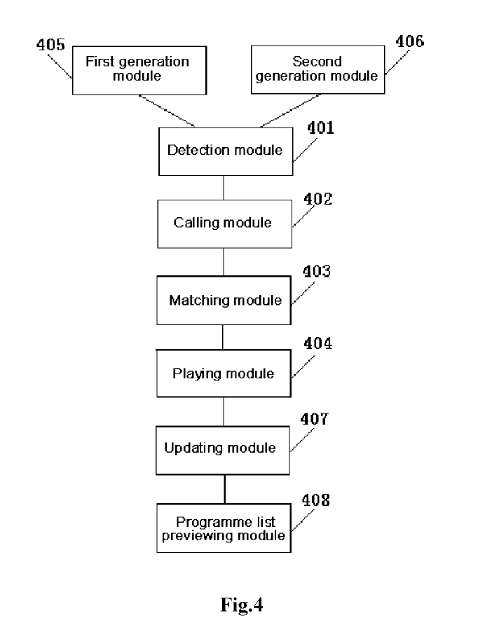

As a more specific embodiment, FIG. 4 is a schematic structural diagram of an apparatus for customizing and playing personalized programme according to another embodiment of the present disclosure.

Preferably, in addition to a detection module 401, a calling module 402, a matching module 403 and a playing module 404, the apparatus for customizing and playing personalized programme according to the embodiment further includes:

a first generation module 405, detecting whether a playing record of the user is stored; generating a programme list according to the playing record, if the playing record of the user is stored, or generating a programme list according to preset default programme information, if the playing record of the user is not stored.

a second generation module 406, generating several groups of programme recommendation information according to the several continuous periods of time with different durations in a time sequence and sending them to the user; and generating several programme sub lists according to programme customizing information returned by the user, and integrating the several programme sub lists to generate the programme list. Furthermore, the second generation module 406 further detects whether a playing record of the user is stored; generates the several groups of programme recommendation information according to the playing record, if the playing record of the user is stored, or generates the several groups of programme recommendation information according to preset default programme information, if the playing record of the user is not stored.

Preferably, the apparatus for customizing and playing personalized programme further includes:

an updating module 407, receiving evaluation information of the user after playing of the programme list is finished for the user, and updating content of the programme list according to the evaluation information.

Preferably, the playing module 404 further monitors local time during playing the programme, compares the local time with periods of time corresponding to subsequent other programme sub lists; prompts the user and pops up a selection box when the local time enters into the periods of time corresponding to the other programme sub lists; and receives a selection instruction inputted by the user for the selection box, and continues to play the programme for the user according to the programme sub list, or starts playing the programme for the user according to a next programme sub list immediately.

Preferably, the apparatus for customizing and playing personalized programme further includes:

a programme list previewing module 408, receiving a call out instruction from the user, and popping up a preview box of the programme list; receiving a selection playing instruction for the preview box of the programme list from the user, extracting the programme sub list pointed by the selection playing instruction, and playing the programme for the user according to the programme sub list immediately. Furthermore, the programme list previewing module 408 further receives an editing instruction for the preview box of the programme list from the user, and modifies content of the programme list in response to the editing instruction and saves the content modified.

An embodiment of the present disclosure further provide a non-volatile computer storage medium, wherein the non-volatile computer storage medium is stored with computer executable instructions which are used to perform any of the methods for customizing and playing personalized programme in the above embodiments.

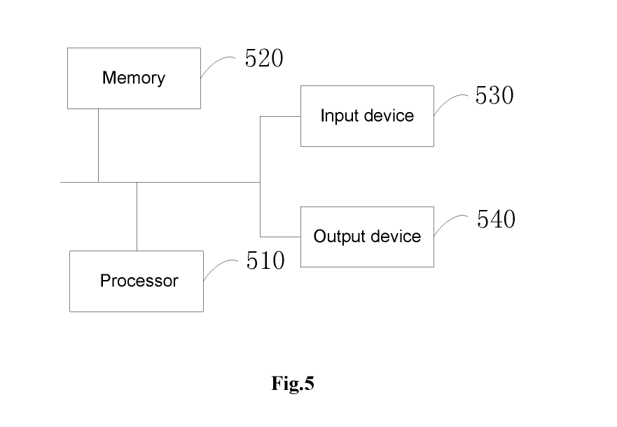

FIG. 5 is a schematic structure diagram of hardware of an electronic device for customizing and playing personalized programme according to an embodiment of the present disclosure. As shown in FIG. 5, the device includes one or more processors 510 and a memory 520, and FIG. 5 illustrates one processor 510 as an example.

The electronic device for customizing and playing personalized programme may further include an input device 530 and an output device 540.

The processor 510, memory 520, input device 530 and output device 540 may be connected with each other through bus or other ways. FIG. 5 illustrates bus connection as an example.

As a non-volatile computer readable storage medium, the memory 520 may be configured to store non-volatile software program, non-volatile computer executable program and module, such as program instruction/module corresponding to the method for customizing and playing personalized programme according to the embodiments of the disclosure (for example, the detection module 301, the calling module 302, the matching module 303 and the playing module, as illustrated in FIG. 3). By executing the non-volatile software program, instruction and module stored in the memory 520, the processor 510 may perform various functional applications of the server and data processing, that is, achieve the method for customizing and playing personalized programme according to the above mentioned embodiments.

The memory 520 may include a program storage area and a data storage area, wherein the program storage area may store the operating system and application which are needed by at least one function, and the data storage area may store data which is created according to use of the device for customizing and playing personalized programme, and the like. Further, the memory 520 may include a high-speed random access memory, and may further include a non-volatile memory, such as at least one of disk memory device, flash memory device or other types of non-volatile solid state memory device. In some embodiments, optionally, the memory 520 may include a memory provided remotely with respect to the processor 510, and such memory may be connected with the device for customizing and playing personalized programme through network. The examples of the network may include but not limited to Internet, intranet, LAN (Local Area Network), mobile communication network and combinations thereof.

The input device 530 may receive inputted digital or character information, and generate key signal input related to the user settings and functional control of the device for customizing and playing personalized programme. The output device 540 may include a display device such as a display screen and the like.

The above one or more modules may be stored in the memory 520. When these modules are executed by the one or more processor 510, the method for customizing and playing personalized programme according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to implement the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk, compact disc and the like, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for customizing and playing personalized programme, which is applied to an electronic device, comprising:
detecting an event that a user boots an Internet television terminal, and recording boot time;
calling a programme list exclusive to the user, wherein the programme list is divided into several programme sub lists according to several continuous periods of time with different durations in a time sequence;
matching the boot time with the several periods of time and obtaining a period of time matched with the boot time; and
extracting a programme sub list corresponding to the period of time matched, and starting playing a programme for the user according to the programme sub list.

2. The method according to claim 1, wherein, the method further comprises a step of generating the programme list:
detecting whether a playing record of the user is stored; and
generating the programme list according to the playing record, if the playing record of the user is stored; or
generating the programme list according to preset default programme information, if the playing record of the user is not stored.

3. The method according to claim 1, wherein, the method further comprises a step of generating the programme list:
generating several groups of programme recommendation information according to the several continuous periods of time with different durations in a time sequence, and sending the several groups of programme recommendation information to the user; and
generating several programme sub lists according to programme customizing information returned by the user, and integrating the several programme sub lists to generate the programme list.

4. The method according to claim 3, wherein, the generating several groups of programme recommendation information further comprises:
detecting whether a playing record of the user is stored; and
generating the several groups of programme recommendation information according to the playing record, if the playing record of the user is stored; or
generating the several groups of programme recommendation information according to preset default programme information, if the playing record of the user is not stored.

5. The method according to claim 2, wherein, when the programme list is generated using the default programme information, the method further comprises:
receiving evaluation information of the user, after playing of the programme list is finished for the user; and
updating content of the programme list according to the evaluation information.

6. The method according to claim 1, wherein, during playing the programme for the user according to the programme sub list, the method further comprises:
monitoring local time during playing the programme, and comparing the local time with periods of time corresponding to subsequent other programme sub lists;
prompting the user and popping up a selection box when the local time enters into the periods of time corresponding to the other programme sub lists; and
receiving a selection instruction inputted by the user for the selection box, and continuing to play the programme for the user according to the programme sub list, or starting playing the programme for the user according to a next programme sub list immediately.

7. The method according to claim 1, wherein, during playing the programme for the user according to the programme sub list, the method further comprises:
receiving a call out instruction from the user, and popping up a preview box of the programme list; and
receiving a selection playing instruction for the preview box of the programme list from the user, extracting the programme sub list pointed by the selection playing instruction, and playing the programme for the user according to the programme sub list immediately.

8. The method according to claim 7, wherein, after popping up a preview box of the programme list, the method further comprises:
receiving an editing instruction for the preview box of the programme list from the user, and modifying content of the programme list in response to the editing instruction and saving the content modified.

9. A non-transitory computer-readable storage medium storing executable instructions that, when executed by an electronic device with a touch-sensitive display, cause the electronic device to:
detect an event that a user boots an Internet television terminal, and record boot time;
call a programme list exclusive to the user, wherein the programme list is divided into several programme sub lists according to several continuous periods of time with different durations in a time sequence;
match the boot time with the several periods of time and obtain a period of time matched with the boot time; and
extract a programme sub list corresponding to the period of time matched, and start playing a programme for the user according to the programme sub list.

10. An electronic device, comprising:
at least one processor; and
a memory communicably connected with the at least one processor for storing instructions executable by the at least one processor, wherein execution of the instructions by the at least one processor causes the at least one processor to:
detect an event that a user boots an Internet television terminal, and record boot time;
call a programme list exclusive to the user, wherein the programme list is divided into several programme sub lists according to several continuous periods of time with different durations in a time sequence;
match the boot time with the several periods of time and obtain a period of time matched with the boot time; and
extract a programme sub list corresponding to the period of time matched, and start playing a programme for the user according to the programme sub list.

11. The electronic device according to claim 10, wherein, the at least one processor is further caused to generate the programme list,
wherein, the step to generate the programme list comprises:
detecting whether a playing record of the user is stored; and
generating the programme list according to the playing record, if the playing record of the user is stored; or
generating the programme list according to preset default programme information, if the playing record of the user is not stored.

12. The electronic device according to claim 10, wherein, the at least one processor is further caused to generate the programme list,
wherein, the step to generate the programme list comprises:
generating several groups of programme recommendation information according to the several continuous periods of time with different durations in a time sequence, and sending the several groups of programme recommendation information to the user; and
generating the several programme sub lists according to programme customizing information returned by the user, and integrating the several programme sub lists to generate the programme list.

13. The electronic device according to claim 12, wherein, the step to generate several groups of programme recommendation information further comprises:
detecting whether a playing record of the user is stored; and
generating the several groups of programme recommendation information according to the playing record, if the playing record of the user is stored; or
generating the several groups of programme recommendation information according to preset default programme information, if the playing record of the user is not stored.

14. The electronic device according to claim 11, wherein, when the programme list is generated using the default programme information, the at least one processor is further caused to:
receive evaluation information of the user after playing of the programme list is finished for the user; and
update content of the programme list according to the evaluation information.

15. The electronic device according to claim 10, wherein, during playing the programme for the user according to the programme sub list, the at least one processor is further caused to:
monitor local time during playing the programme, and compare the local time with periods of time corresponding to subsequent other programme sub lists;
prompt the user and pop up a selection box when the local time enters into the periods of time corresponding to the other programme sub lists; and
receive a selection instruction inputted by the user for the selection box, and continue to play the programme for the user according to the programme sub list, or start playing the programme for the user according to a next programme sub list immediately.

16. The electronic device according to claim 10, wherein, during playing the programme for the user according to the programme sub list, the at least one processor is further caused to:
receive a call out instruction from the user, and pop up a preview box of the programme list; and
receive a selection playing instruction for the preview box of the programme list from the user, extract the programme sub list pointed by the selection playing instruction, and play the programme for the user according to the programme sub list immediately.

17. The electronic device according to claim 16, wherein, after the preview box of the programme list is popped up, at least one processor is further caused to:
receive an editing instruction for the preview box of the programme list from the user, and modify content of the programme list in response to the editing instruction and save the content modified.
